(19) United States
(12) Patent Application Publication
(10) Pub. No.: US 2006/0115224 A1
(43) Pub. Date: Jun. 1, 2006

(54) Single-mode optical fiber, optical fiber cable, optical fiber cord, and method for ensuring service life of optical fiber

(75) Inventors: Hiroshi Kutami, Sakura-shi (JP); Shoichiro Matsuo, Sakura-shi (JP); Kuniharu Himeno, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD.

(21) Appl. No.: 11/287,284

(22) Filed: Nov. 28, 2005

(30) Foreign Application Priority Data
Nov. 30, 2004 (JP) P2004-346053

(51) Int. Cl. G02B 6/02

(52) U.S. Cl. 385/123

(57) ABSTRACT

A single-mode optical fiber, cable, cord, and a method for ensuring a service life of the fiber are provided. The fiber has a core and a cladding, the fiber having a cut-off wavelength that exhibits a single-mode transmission in a 1.31 μm wavelength band. A relative refractive index difference of the core with respect to the cladding is adjusted such that a bending loss, when a bend is applied in a radius smaller than a limit bending radius of the fiber, becomes greater than a detection limit value. The limit bending radius is calculated from a relationship between a bending radius applied to the optical fiber and a failure probability which occurs after a time period. The method includes measuring a loss and ensuring that a failure probability of the fiber during a service life falls within a failure probability used for setting the limit bending radius.

### CROSS-REFERENCE TO RELATED APPLICATIONS

Priority is claimed from Japanese Patent Application No. 2004 346053, filed Nov. 30, 2004, the content of which is incorporated herein by reference.

### BACKGROUND OF THE INVENTION

In recent years, optical fibers having a low transmission loss caused by a bend (bending loss) have been developed in light of ease of manufacturing and ease of laying cables. Optical fibers are known which have a transmission loss of about 0.0008 dB/turn even when they are bent to a bending radius of about 2.5 mm, for example, so that they can be employed in a small bending radius, and such optical fibers can be used even when they are bent to a extremely small radius at an early stage after the installation (see, for example, Daizo Nishioka, et al., Development of a Holey Fiber with Ultra-low Bending Loss, Technical Report of IEICE, OFT2003-63; Bing Yao, et al., Development of Holey Fibers, Technical Report of IEICE, OFT2003-27).

It has bee know that when an optical fiber that is designed for use in a typical transmission path is used while it is bent in a small bending radius, cracks present on the surface of the optical fiber gradually extends due to a phenomenon called fatigue, and the optical fiber may be broken after a certain time period. In general, since it is desirable that cables for being laid within walls of houses need not be replaced until the houses are rebuilt, a life of about 20 years is required for cables. As for cables that are laid outdoor, a life of about 20 years is also required since laying cables requires traffic regulation. However, when an optical fiber is bent to an extremely small radius, the cable may be broken in only a matter of few years.

### SUMMARY OF THE INVENTION

An exemplary embodiment of the present invention provides a single-mode optical fiber comprising a core and a cladding, the optical fiber having a cut-off wavelength that exhibits a substantially single-mode transmission in a 1.31 μm wavelength band, in which a relative refractive index difference of the core with respect to the cladding is adjusted such that a bending loss, when a bend is applied in a radius smaller than a limit bending radius of the single-mode optical fiber, becomes greater than a detection limit value, the limit bending radius being calculated from a relationship between a bending radius applied to the optical fiber and a failure probability occurs after a predetermined time period.

Another exemplary embodiment of the present invention provides an optical fiber cable comprising the above-described single-mode optical fiber according to the present invention.

Another exemplary embodiment of the present invention provides an optical fiber cord comprising the above-described single-mode optical fiber according to the present invention.

Another exemplary embodiment of the present invention provides a method for ensuring a service life of above-described single-mode optical fiber, or of a single-mode optical fiber used in an optical fiber cable or of a single-mode optical fiber used in an optical fiber cord according to the present invention. The method includes measuring a loss in the longitudinal direction of the single-mode optical fiber that is laid using an optical time domain reflectometer (OTDR) technique or by measuring a transmission loss in the entire length of the single-mode optical fiber, and ensuring that a failure probability of the single-mode optical fiber during a predetermined service life falls within a failure probability used for setting a limit bending radius by confirming that the measured loss is smaller than a beading loss that is generated when a bend having a bending radius smaller than the limit bending radius is applied to the single-mode optical fiber.

The optical fiber according to an exemplary embodiment of the present invention is adjusted such that the bending loss, when a bend is applied in a radius smaller than the limit bending radius of the optical fiber, becomes greater than the detection limit value that is calculated from the relationship between a bending radius applied to the optical fiber and a failure probability that occurs after a time period. Thus, the loss in the longitudinal direction of a single-mode optical fiber used in the optical fiber cable or optical fiber cord that is laid is measured using the OTDR technique or by measuring the transmission loss in the entire length of the optical fiber.

### BRIEF DESCRIPTION OF THE DRAWINGS

FIG. 1 is a graph showing the relationship between bending radii and failure frequencies of an optical fiber;

FIG. 2 is a graph showing an example of a step index type refractive index profile of an optical fiber according to an exemplary embodiment of the present invention; and

FIG. 3 is a graph of an example of a trench refractive index profile of an optical fiber according to an exemplary embodiment of the present invention.

### DETAILED DESCRIPTION OF EXEMPLARY EMBODIMENTS OF THE INVENTION

A single-mode optical fiber according to an exemplary embodiment of the present invention (hereinafter, referred to as an “optical fiber”) has a cut-off wavelength that exhibits a substantially single-mode transmission in the 1.31 μm wavelength band. The optical fiber is adjusted such that the bending loss when a bend is applied in a radius smaller than the limit bending radius of the optical fiber becomes greater than the detection limit value that is calculated from the relationship between a bending radius applied to the optical fiber and a failure probability occurs after a time period.

The failure probability F of an optical fiber under certain stress after time t_{z} elapses can be calculated from the following Formula (1) (see Y. Mitsunaga et. al., “Failure prediction for long length optical fiber based on proof testing,” J. Appl. Phys., 53 (1982) 4847-485).

$$F = 1 - exp ( {N}_{p} {L}_{0} \{ 1 - {[ 1 + {( \frac{{ɛ}_{z}}{{ɛ}_{p}} )}^{n} \frac{{t}_{z}}{{t}_{p}} ]}^{\frac{m}{n - 2}} \} ) \qquad ( 1 )$$

In Formula (1), Nₚ is the failure number per unit length during a proof test, Lₒ is a fiber effective length under uniform stress, ε_{z} is a maximum stress in cross section, εₚ is a stress applied during the proof test, tₚ is a duration during which the stress is applied during the proof test, m is Weibull parameter, and n is a stress collosion susceptibility parameter.

Among the above parameters, εₚ and tₚ, which are conditions for the proof test, and the length Lₒ of the portion of the optical fiber to which the stress is applied can be modified arbitarily. Other parameters represent physical properties of the optical fiber and are varied depending on manufacturing conditions of the optical fibers or the like.

When an optical fiber is bent, ε_{z} and Lₒ are given by the following Formulae (2) and (3):

$$\begin{matrix}{ɛ}_{z} = \frac{r}{R} & ( 2 ) \\ {L}_{0} = 2 π R & ( 3 )\end{matrix}$$

In Formulae (2) and (3), r is a radius of a glass portion of the optical fiber, and R is the bending radius of the optical fiber.

It can be seen from the above formulae that the failure probability of the optical fiber increases as the bending radius is reduced.

Furthermore, the failure probability decreases as the radius of a glass portion of the optical fiber becomes smaller. However, since an optical fiber is generally broken when a stress of about 4 GPa is applied, it is considered that a limit diameter of the glass portion is about 80 μm for optical fibers that are assumed to be subjected to a large tension when they are laid as a transmission line or the like.

The failure probability decreases as the stress that is applied during a proof is decreased.

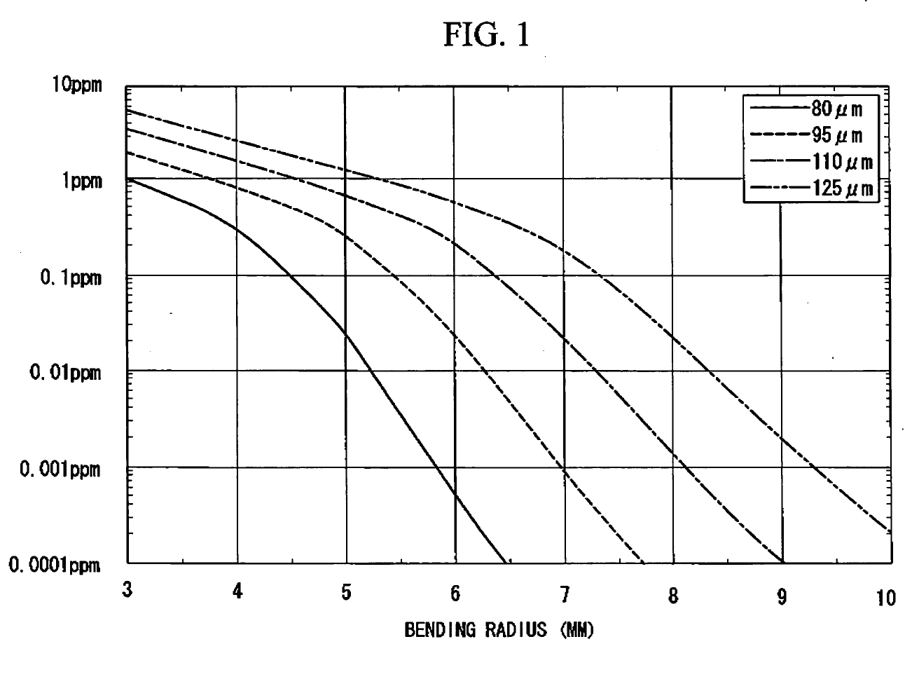

In FIG. 1, the relationship between the bending radii and failure frequencies after 20 years of optical fibers having various cladding diameters is shown. It is possible to reduce the failure probability as a proof level becomes higher. In this calculation, a proof level of 2% was assumed. This value is used for optical fibers for submarine cables that require high reliability. Furthermore, in the calculation, it was assumed that Nₚ was 0.015 times/km, tₚ was 1 second, m was 3, and n was 23.

The calculation results shown in FIG. 1 indicate that the failure probability increases as a bending radius applied to an optical fiber becomes smaller, and that even an optical fiber having the glass portion with a diameter of 80 μm exhibits a failure probability after 20 years of more than 1 ppm when it was bent to a radius of 3 mm or less.

The upper limits of the service life and the failure probability of optical fibers vary depending on the topology and application in which the optical fibers are laid. However, when a small bending is applied to optical fibers in the longitudinal direction thereof, the optical fibers may be broken and the failure probability may exceed the upper limit during their service life. In the following description, a small bending radius that causes break of an optical fiber exceeding the upper limit of the failure probability during the service life of the optical fibers is referred to as a “limit bending radius.” This limit bending radius is defined in terms of the mechanical strength of an optical fiber that is determined by a cladding diameter of the optical fiber, and is different from another term “allowable bending radius” that represents a bending limit in terms of the transmission characteristics.

If an optical fiber having a small allowable bending radius which can be used when it is bent to a small radius is not properly designed, the transmission loss may not be increased even when it is bent to the limit bending radius or smaller, which makes detection of any bend smaller than this limit difficult. To solve this, an exemplary embodiment of the present invention provides an optical fiber that exhibits a significant increase in loss when it is bent to a bending radius smaller tan the limit bending radius, thereby allowing detection of generation of such a sharp bend.

Since it is difficult to distinguish a local increase in loss caused by a bend from the average transmission loss for the entire length of the optical fiber, an optical time domain reflectometer (OTDR) must be used to detect a loss increase caused by a bend having a bending radius smaller than the limit bending radius. For this mason, since the bending loss in the limit bending radius must be greater than the detection limit of an OTDR, it is advantageous that the bending loss in the limit bending radius is about 0.01 dB/turn or greater. More specifically, it is preferable that an optical fiber be designed to exhibit bending loss in the allowable bending radius which is reduced to a level sufficient for practical applications, but it exhibits a large bending loss of about 0.01 dB/turn or greater, and preferably about 0.04 dB/turn or greater, when a bend having a bending radius smaller than the limit bending radius is applied. In such an optical fiber, it is possible to ensure sufficiently low failure probability during the service life of the optical fiber.

Structural parameters, such as the cladding diameter, the mode field diameter, the core diameter, and the refractive index profile, of optical fibers of an exemplary embodiment of the present invention are not particularly limited as long as the optical fibers have a cut-off wavelength that exhibits a substantially single mode mission in the 1.31 μm wavelength band and have the bending loss characteristics in which the bending loss becomes greater than the detection limit value when a bend is applied in a radius smaller than the limit bending radius of the optical fiber.

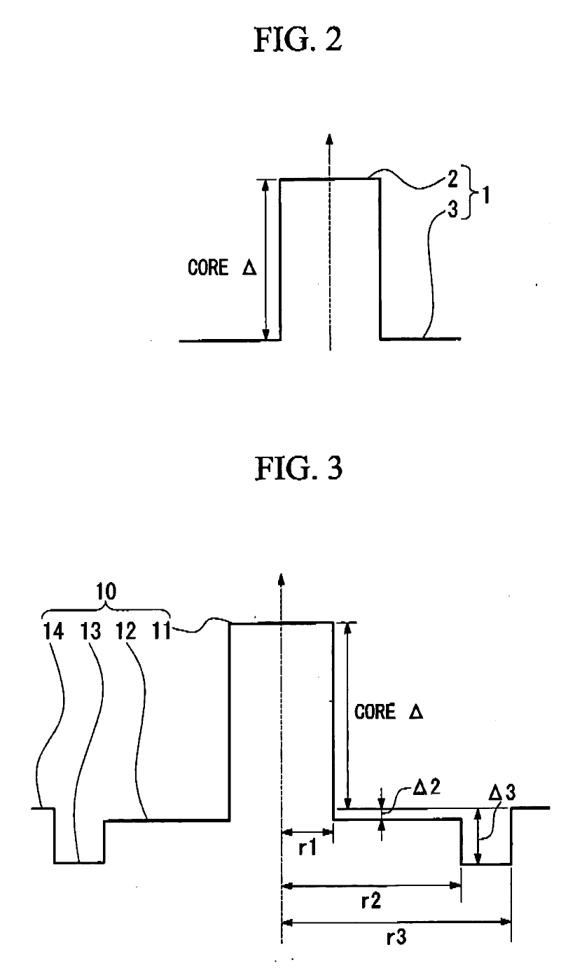

FIGS. 2 and 3 are diagrams showing examples of refractive index profiles of optical fibers according to exemplary embodiments of the present invention,

FIG. 2 shows an optical fiber 1 that has a typical step index type refractive index profile. The optical fiber 1 is made of silica-based glass, and includes a core 2 having a higher refractive index and a cladding 3 disposed around the outer periphery of the core 2.

FIG. 3 shows an optical fiber 10 that has a trench refractive index profile. The optical fiber 10 is made of silica-based glass, and includes a central core region 11 having a higher refractive index, an inner cladding region 12 disposed around the outer periphery of the core region 11, a trench portion 13 having a lower refractive index disposed around the outer periphery of the inner cladding region 12, and a cladding 14 disposed around the outer periphery of the trench portion 13.

In the present invention, among structural parameters of optical fibers, it is preferable that the relative refractive index difference of the core with respect to the cladding (hereinafter, referred to as a “core Δ”) be adjusted so that the bending loss becomes greater than the detection limit value when a bend is applied in a radius smaller than the limit bending radius of the optical fiber. In an optical fiber designed to have the same cladding diameter and the same cut-off wavelength, as the core Δ is varied, the bending loss in the same bending radius also varies.

In the optical fibers 1 and 10 having refractive index profiles shown in FIGS. 2 and 3, respectively, the core Δ is varied while setting the cladding diameter and the cut-off wavelength to constant. The bending loss in the limit bending radius tends to increase with a decrease in the core Δ whereas the bending loss in the limit bending radius tends to decrease with an increase in the core Δ. As described previously, the bending loss in the limit bending radius when the loss in the longitudinal direction of an optical fiber is measured using, for example, the OTDR technique. It is advantageous that this value be about 0.01 dB/turn or greater, which is the detection limit of the technique, and that the bending loss be about 0.04 dB/turn or greater. Accordingly, an optical fiber according to an exemplary embodiment of the present invention preferably has the core Δ set such that the bending loss in a limit bending radius is about 0.01 dB/turn or greater, and preferably is no less than about 0.04 dB/turn and no more than about 10 dB/turn.

The above-described optical fiber is evaluated using a method for ensuring a service life according to an exemplary embodiment of the present invention. In the method, the loss in the longitudinal direction of a single-mode optical fiber that is laid is measuring the OTDR technique or by measuring the transmission loss in the entire length of the optical fiber. The method ensures that the failure probability of the single-mode optical fiber during a service life falls within the failure probability used for setting the limit bending radius by confirming that the measured loss is smaller than the bending loss that is generated when a bend having a bending radius smaller than the limit bending radius is applied to the optical fiber.

The optical fiber according to an exemplary embodiment of the present invention may be used in an optical fiber cable or an optical fiber cord. An optical fiber cable or optical fiber cord having the optical fiber according to an exemplary embodiment of the present invention may be laid indoor or may be laid outdoor. The loss in the longitudinal direction of a single-mode optical fiber used in the optical fiber cable or optical fiber cord that is laid is measured using the OTDR technique or by measuring the transmission loss in the entire length of the optical fiber. The method ensures that the failure probability of the single-mode optical fiber during a service life falls within the failure probability used for setting the limit bending radius by confirming that the measured loss is smaller than the bending loss that is generated when a bend having a bending radius smaller than the limit bending radius is applied to the optical fiber.

As described previously, in the optical fiber according to an exemplary embodiment of the present invention and the optical fiber cable or optical fiber cord having such an optical fiber, it is ensured that the failure probability of the single-mode optical fiber during a service life falls within the failure probability used for setting the limit bending radius. Thus, it is possible to reduce troubles, such as breakage during the service life, as well as improving the reliability.

### EXAMPLE

### Example 1

In an optical fiber 1 that has typical step index type refractive index profile as in FIG. 2 and a cladding diameter of 125 μm and a fiber cut-off of 1.26 mm, the mode field diameter and the bending loss were calculated while varying the core Δ, which is the relative refractive index difference of the core 2 with respect to the cladding 3. The results are listed in Table 1.

TABLE 1
Optical

| characteristics | Measure- | | Core Δ | | | | | | | | |
|---|---|---|---|---|---|---|---|---|---|---|---|
| Cut-off | ment | Unit | 0.35% | 0.40% | 0.50% | 0.55% | 0.70% | 0.75% | 0.80% | 0.85% | 0.90% |
| wavelength | wavelength | μm | 1.26 | 1.26 | 1.26 | 1.26 | 1.26 | 1.26 | 1.26 | 1.26 | 1.26 |
| Mode field | 1.31 μm | μm | 9.1 | 8.5 | 7.5 | 7.2 | 6.3 | 6.1 | 5.9 | 5.7 | 5.6 |
| diameter | 1.55 μm | μm | 10.2 | 9.6 | 8.5 | 8.1 | 7.2 | 6.9 | 6.7 | 6.5 | 6.3 |
| Bending loss at | 1.55 μm | dB/turn | 10 | 6 | 1 | 6 × 10⁻¹ | 4 × 10⁻² | 1 × 10⁻² | 0.5 × 10⁻² | 0.2 × 10⁻² | 0.1 × 10⁻² |
| bending radius of | | | | | | | | | | | or less |
| 5.5 mm | | | | | | | | | | | |
| Bending loss at | 1.625 μm | dB/turn | 18 | 10 | 3 | 1 | 2 × 10⁻¹ | 5 × 10⁻² | 3 × 10⁻² | 1 × 10⁻² | 0.4 × 10⁻³ |
| beading radius of | | | | | | | | | | | |
| 5.5 mm | | | | | | | | | | | |

When the service life of the optical fiber is assumed to be 20 years and the failure probability is assumed to be 1 ppm or less, it is confirmed from FIG. 1 that a limit bending radius of the optical fiber is 5.5 mm because the optical fiber has a cladding diameter of 125 μm.

As shown in Table 1, when the core Δ is greater than about 0.80%, the loss caused by a bend is reduced to about 0.01 dB/turn or less in a limit bending radius of 5.5 mm, which makes measurement using an OTDR difficult.

When the core Δ is about 0.75% or less, a bending loss when bent to a 5.5 mm radius becomes about 0.014 dB/turn or greater. Since the detection limit of an OTDR is typically about 0.01 dB/point it is possible to detect a bend that causes a failure probability of 1 ppm or higher after 20 years of the service life passes. More preferably, when the core Δ is about 0.7% or less, the bending loss when bent to a 5.5 mm radius becomes about 0.044 dB/turn or greater, which is more easily detected.

When the core Δ is about 0.50% or less, the bending loss at a wavelength of 1550 nm when bent to a bending radius of 5.5 mm becomes about 1 dB/turn or greater. This condition is relatively safe since the abnormal loss can be distinguished from an average transmission loss in the entire length of the optical fiber without using an OTDR.

Furthermore, when the core Δ is about 0.35% or less, the bending loss at a wavelength of 1550 nm when bent to a bending radius of 5.5 mm becomes about 10 dB/turn or greater. The loss becomes too high and practical use becomes virtually impossible. For this reason, this condition is safe and the fiber is not bent to a bending radius smaller than the limit bending radius.

The present invention is directed to an optical fiber in which an increase in the loss caused by a bend having a bending radius smaller than the limit bending radius is detectable using an OTDR, and the measurement wavelength is not limited to 1550 nm. Measurements were carried out at a wavelength of 1550 nm in the above-described example since an OTDR that is typically used often includes a light source hang a wavelength of 1310 nm or 1550 nm. However, a longer measurement wavelength is more advantageous since an increase in the loss caused by a bend is increased and the increase is more easily detectable. For example, as shown by the calculated results taken at a wavelength of 1625 nm that are also listed in Table 1, an optical fiber having a core Δ of about 0.85% exhibited the bending loss in the limit bending radius that was about 0.01 dB/turn, thereby making the bend detectable.

### Example 2

Another example was studied using an optical fiber 10 having a trench refractive index profile as in FIG. 3. In this example, the following parameters were used: the radius of the central core region 11 was r1, the radius of the inner cladding region 12 was r2, the radius of the trench portion 13 that is provided around the outer periphery of the inner cladding region 12 and has lower refractive index than that of the inner cladding region 12 was r3, and the relative refractive index difference of the central core region 11 with respect to the cladding 14 was used as a core Δ. The relative refractive index difference of the inner cladding region 12 was Δ2 and the relative refractive index difference of the trench portion 13 was Δ3. A single-mode optical fiber having a cladding diameter of 125 μm was designed so tat the fiber cutoff was 1.26 μm, r2/r1 was 3.5, r3/r1 was 5.5, Δ2 was 0%, Δ3 was −0.250%, and the mode field diameter and the bending loss were calculated while varying the core Δ. The results were listed in Table 2.

TABLE 2

| Optical | | | | | | | | | |
|---|---|---|---|---|---|---|---|---|---|
| characteristics | Measure- | | | Core Δ | | | | | |
| Cut-off | ment | | Unit | 0.35% | 0.60% | 0.65% | 0.70% | 0.75% | 0.80% |
| wavelength | wavelength | | μm | 1.26 | 126 | 1.26 | 1.26 | 1.26 | 1.26 |
| Mode field | 1.31 | μm | μm | 8.9 | 6.8 | 6.5 | 6.3 | 6.1 | 5.9 |
| diameter | 1.55 | μm | μm | 10.1 | 7.7 | 7.4 | 7.1 | 6.9 | 6.7 |
| Bending loss at | 1.55 | μm | dB/turn | 5 × 10⁻¹ | 4 × 10⁻² | 2 × 10⁻² | 0.8 × 10⁻² | 0.4 × 10⁻² | 0.2 × 10⁻² |
| bending radius of | | | | | | | | | |
| 5.5 mm | | | | | | | | | |
| Bending loss at | 1.625 | μm | dB/turn | 8 × 10⁻¹ | 1 × 10⁻² | 6 × 10⁻² | 3 × 10⁻¹ | 1 × 10⁻² | 0.7 × 10⁻² |
| bending radius of | | | | | | | | | |
| 5.5 mm | | | | | | | | | |

When the service life of the optical fiber is assumed to be 20 years and the failure probability is assumed to be 1 ppm or less, it is confirmed from FIG. 1 that a limit bending radius of the optical fiber is 5.5 mm because the optical fiber has a cladding diameter of 125 μm.

In an optical fiber having such an refractive index profile, when the core Δ of the optical fiber is about 0.7% or higher, the loss caused by a bend with a limit bending radius of 5.5 mm is reduced to about 0.01 dB/turn or less, which is the detectable limit of an OTDR. Thus, measurement using an OTDR becomes difficult.

When core Δ is about 0.65% or less, a bending loss when bent to a 5.5 mm radius becomes about 0.02 dB/turn or greater, which is a loss increase higher than the detection limit of an OTDR of about 0.01 dB/turn or greater. In this case, since the bend is sufficiently detectable using an OTDR, it is ensure the break probability in the service life after 20 years to be less than 1 ppm. For this reason, the core Δ of the optical fiber is preferably about 0.65% or less. Furthermore, when the core Δ is about 0.6% or less, the bending loss becomes about 0.04 dB/turn or greater, which makes a bend further detectable.

The present invention is directed to an optical fiber in which an increase in the loss caused by a bend having a bending radius smaller than the limit bending radius is detectable using an OTDR, and the measurement wavelength is not limited to 1550 nm. Measurements were carried out at a wavelength of 1550 nm in the above-described example since an OTDR that is typically used often include a light source having a wavelength of 1310 nm or 1550 nm. However, a longer measurement wavelength is preferred since an increase in the loss caused by a bend is increased and the increase is more easily detectable. For example, as shown by the calculated results taken at a wavelength of 1625 nm that are also listed in Table 2, the bending loss in the limit bending radius was about 0.01 dB/turn with an optical fiber having a core Δ of about 0.75%, thereby making the bend detectable.

While exemplary embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A single-mode optical fiber comprising a core and a cladding, the optical fiber having a cut-off wavelength that exhibits a substantially single-mode transmission in a 1.31 μm wavelength band,
wherein a relative refractive index difference of the core with respect to the cladding is adjusted such that a bending loss, when a bend is applied in a radius smaller than a limit bending radius of the single-mode optical fiber, becomes greater than a detection limit value, the limit bending radius being calculated from a relationship between a bending radius applied to the optical fiber and a failure probability which occurs after a time period.

2. The single-mode optical fiber according to claim 1, wherein the limit bending radius of the optical fiber is calculated using the following Formulae (1)-(3):
$$\begin{matrix}F = 1 - exp ( {N}_{p} {L}_{0} \{ 1 - {[ 1 + {( \frac{{ɛ}_{z}}{{ɛ}_{p}} )}^{n} \frac{{t}_{z}}{{t}_{p}} ]}^{\frac{m}{n - 2}} \} ) & ( 1 ) \\ {ɛ}_{z} = \frac{r}{R} & ( 2 ) \\ {L}_{0} = 2 π R & ( 3 )\end{matrix}$$
wherein F is the failure probability, t_{z} is an elapsed time, Nₚ is the failure number per unit length during a proof test, Lₒ is a fiber effective length under uniform stress, ε_{z} is a maximum stress in cross section, εₚ is a stress applied during the proof test, tₚ is a duration during which the stress is applied during the proof test, m is a Weibull parameter, n is a stress collosion susceptibility parameter, r is a radius of a glass portion of the optical fiber, and R is the bending radius of the single-mode optical fiber.

3. The single-mode optical fiber according to claim 1, wherein the bending loss in the limit bending radius is no less than about 0.01 dB/turn and no more than about 10 dB/turn.

4. The single-mode optical fiber according to claim 1, wherein the bending loss in the limit bending radius is no less than about 0.04 dB/turn and to more than about 10 dB/turn.

5. An optical fiber cable comprising the single-mode optical fiber according to claim 1.

6. An optical fiber cord comprising the single-mode optical fiber according to claim 1.

7. A method for ensuring a service life of a single-mode optical fiber having a core and a cladding, the optical fiber having a cut-off wavelength that exhibits a substantially single-mode transmission in a 1.31 μm wavelength band,
wherein a relative refractive index difference of the core with respect to the cladding is adjusted such that a bending loss, when a bend is applied in a radius smaller than a limit bending radius of the single-mode optical fiber, becomes greater than a detection limit value, the limit bending radius being calculated from a relationship between a bending radius applied to the optical fiber and a failure probability which occurs after a time period,
the method comprising:
measuring a loss in the single-mode optical fiber; and
ensuring that a failure probability of the single-mode optical fiber during a service life falls within a failure probability used for setting the limit bending radius by confirming that the measured loss is smaller than a bending loss that is generated when a bend having a bending radius smaller than the limit bending radius is applied to the single-mode optical fiber.

8. The method of claim 7, wherein the loss is measured in a longitudinal direction of the single mode optical fiber that is laid using an optical time domain reflectometer (OTDR) technique.

9. The method for ensuring a service life of the single-mode optical fiber according to claim 8, wherein the single-mode optical fiber is used in an optical fiber cable.

10. The method for ensuring a service life of the single-mode optical fiber according to claim 8, wherein the single-mode optical fiber is used in an optical fiber cord.

11. The method of claim 7, wherein the loss that is measured in a longitudinal direction of the single mode optical fiber that is laid is measured by measuring a transmission loss in an entire length of the single mode optical fiber.

12. The method of claim 11, wherein the single-mode optical fiber is used in an optical fiber cable.

13. The method of claim 11, wherein the single-mode optical fiber is used in an optical fiber cord.
